(19) United States
(12) Patent Application Publication
(10) Pub. No.: US 2026/0014679 A1
(43) Pub. Date: Jan. 15, 2026

(54) TORQUE MULTIPLIER WRENCH

(71) Applicant: THE BOEING COMPANY, Arlington, VA (US)

(72) Inventors: John D. SAILING, Covington, WA (US); Arjun MATHUR, Seattle, WA (US)

(21) Appl. No.: 18/773,427

(22) Filed: Jul. 15, 2024

(51) Int. Cl. B25B 17/02; B25B 13/48

(52) U.S. Cl. CPC B25B 17/02; B25B 13/481

(57) ABSTRACT

The present disclosure provides a tool for tightening or loosening nuts (e.g., B-nuts that couple aircraft fuel lines). An apparatus includes a crowfoot, a clasp, and a first gear. The crowfoot defines a first opening sized to engage a first nut. The clasp closes such that the clasp defines a second opening sized to engage a second nut. The clasp includes gear teeth positioned along a portion of an outer perimeter of the clasp. The first gear engages the gear teeth such that turning the first gear causes the clasp to turn to rotate the second nut such that the second nut engages the first nut when the crowfoot is engaged with the first nut and when the clasp is engaged with the second nut.

### FIELD

Aspects of the present disclosure relate to tools for tightening or loosening fasteners (e.g., nuts). For example, the present disclosure describes tools for tightening or loosening B-nuts (e.g., for coupling fuel lines on aircraft).

### BACKGROUND

Nuts are used to couple together different components. For example, in an aircraft, B-nuts (e.g., male B-nuts and female B-nuts) are used to couple together fuel lines. In existing systems, a human operator uses a wrench to tighten the B-nuts to form couplings. These couplings, however, may be located in areas that are difficult to reach. For example, couplings that are located in the wings of the aircraft may be obstructed by other components in the wings. As a result, it may be difficult for the wrench to reach and tighten the couplings.

Additionally, to satisfy regulations and to increase safety, these B-nuts may need to be tightened to a certain torque. In existing processes, the operator may count the number of times the B-nuts have turned to calculate the torque. When the couplings are difficult to reach, it may be difficult for the operator to count the number of turns of the B-nuts and to calculate the torque.

### SUMMARY

The present disclosure provides a tool for tightening or loosening nuts (e.g., B-nuts that couple aircraft fuel lines). According to an aspect, an apparatus includes a crowfoot, a clasp, and a first gear. The crowfoot defines a first opening sized to engage a first nut. The clasp closes such that the clasp defines a second opening sized to engage a second nut. The clasp includes gear teeth positioned along a portion of an outer perimeter of the clasp. The first gear engages the gear teeth such that turning the first gear causes the clasp to turn to rotate the second nut such that the second nut engages the first nut when the crowfoot is engaged with the first nut and when the clasp is engaged with the second nut.

The apparatus may include a pin. The clasp may define a first aperture and a second aperture. The first aperture may align with the second aperture when the clasp is closed around the second nut. The pin may extend through the first aperture and the second aperture to lock the clasp.

The apparatus may include a housing and a strap. The first gear and the crowfoot may be positioned within the housing. The strap may couple to the housing and secure the clasp to the housing.

The apparatus may include a shaft coupled to the first gear. Turning the shaft may cause the first gear to turn.

The apparatus may include a second gear that engages the first gear such that turning the second gear causes the first gear to turn.

The apparatus may include a gate and a lever. The gate closes to secure the clasp between the crowfoot and the gate. The lever locks the gate.

The apparatus may include a lever that rotates the crowfoot to align the first opening with the first nut.

The apparatus may include a lever that engages a locking plate to the crowfoot to secure the crowfoot.

According to another aspect, a method includes engaging a crowfoot with a first nut such that the first nut is positioned within a first opening defined by the crowfoot and closing a clasp around a second nut such that the second nut is positioned within a second opening defined by the clasp. The clasp includes gear teeth positioned along a portion of an outer perimeter of the clasp. The first opening is aligned with the second opening. The method also includes turning a first gear engaged with the gear teeth such that the clasp turns to rotate the second nut such that the second nut engages the first nut.

The method may include, when the clasp is closed around the second nut, inserting a pin into a first aperture and a second aperture defined by the clasp to lock the clasp.

The method may include coupling a strap to a housing to secure the clasp to the housing. The first gear and the crowfoot may be positioned within the housing.

The method may include turning a shaft coupled to the first gear. Turning the shaft may cause the first gear to turn.

The method may include turning a second gear engaged with the first gear. Turning the second gear may cause the first gear to turn.

The method may include closing a gate to secure the clasp between the crowfoot and the gate and moving a lever to lock the gate.

The method may include moving a lever to rotate the crowfoot to align the first opening with the first nut.

The method may include moving a lever to engage a locking plate to the crowfoot to secure the crowfoot.

According to another aspect, an apparatus includes a crowfoot, a clasp, and a gear train. The crowfoot defines a first opening sized to engage a female B-nut. The clasp closes to define a second opening sized to engage a male B-nut. The clasp includes gear teeth positioned along a portion of an outer perimeter of the clasp. The gear train includes a first gear and a second gear. The first gear engages the gear teeth. Turning the second gear causes the first gear to turn. Turning the first gear causes the clasp to rotate the male B-nut such that the male B-nut engages the female B-nut when the crowfoot is engaged with the female B-nut and when the clasp is engaged with the male B-nut.

The apparatus may include a gate and a lever. The gate may close to secure the clasp between the crowfoot and the gate. The lever may lock the gate.

The apparatus may include a lever that may rotate the crowfoot to align the first opening with the female B-nut.

The apparatus may include a lever that may engage a locking plate to the crowfoot to secure the crowfoot.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIGS. 1A through 1C illustrate an example tool.

FIG. 1D illustrates an example driver.

FIG. 1E illustrates an example portion of the tool of FIG. 1A.

FIGS. 1F through 1K illustrate an example tool.

FIGS. 2A through 2G illustrate an example tool.

FIG. 2H illustrates an example nut coupling.

FIGS. 21 through 20 illustrate an example tool engaging the nut coupling.

FIGS. 3A through 3C illustrate an example coupler.

FIG. 4 is a flowchart of an example method for tightening or loosening a nut.

### DETAILED DESCRIPTION

The present disclosure describes a tool for tightening or loosening mechanical nuts. For example, the tool may be used to tighten or loosen a B-nut coupling for a fuel line in an aircraft. The tool includes a crowfoot that engages a first nut (e.g., a female B-nut) and a clasp that engages a second nut (e.g., a male B-nut).

The tool may hold the first nut still or steady while turning the second nut to tighten or loosen the coupling of the two nuts. The tool includes one or more gears (e.g., a gear train) that engage the clasp. Turning the gears (e.g., by turning a shaft) causes the clasp to rotate to turn the second nut.

The crowfoot, the clasp, and the one or more gears may be arranged in different ways in different aspects to allow the tool to fit into different shaped spaces. For example, the crowfoot, the clasp, and the one or more gears may be arranged to resemble a flat disc such that the tool may fit in a space with limited width or height. As another example, the crowfoot, the clasp, and the one or more gears may be arranged to resemble a curved arm such that the tool may fit around obstructions. As a result, different aspects of the tool may be used to tighten nuts in various spaces.

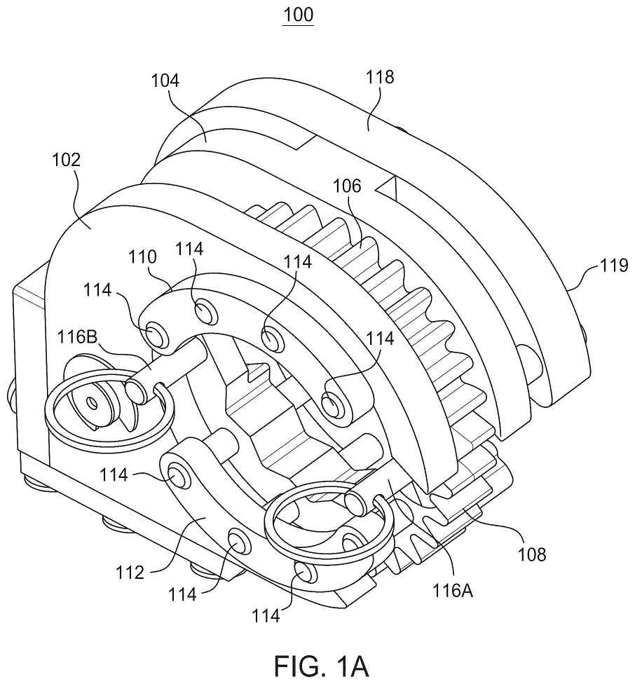

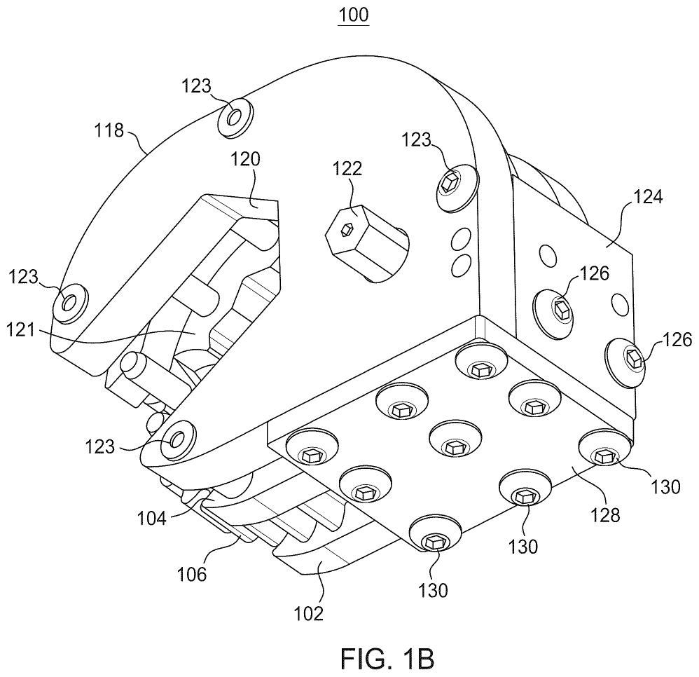

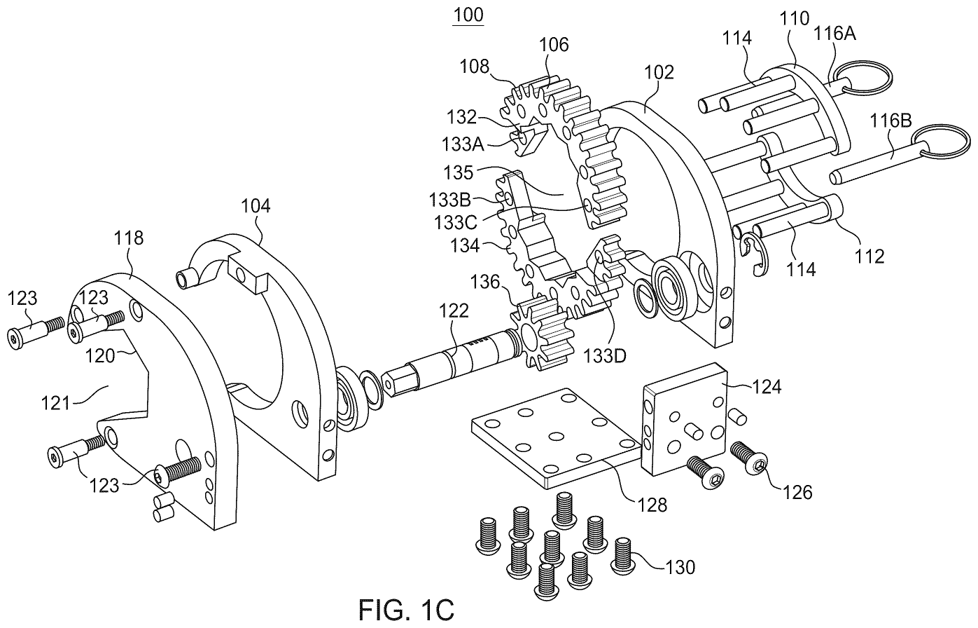

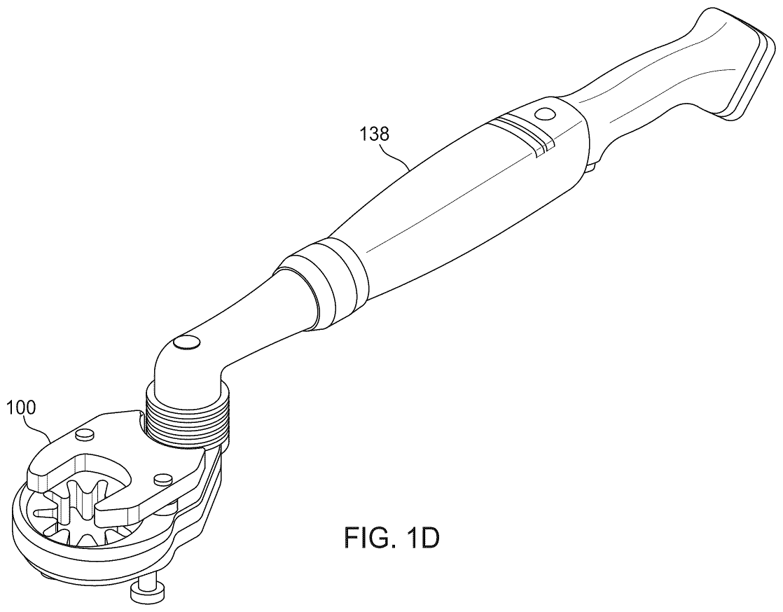

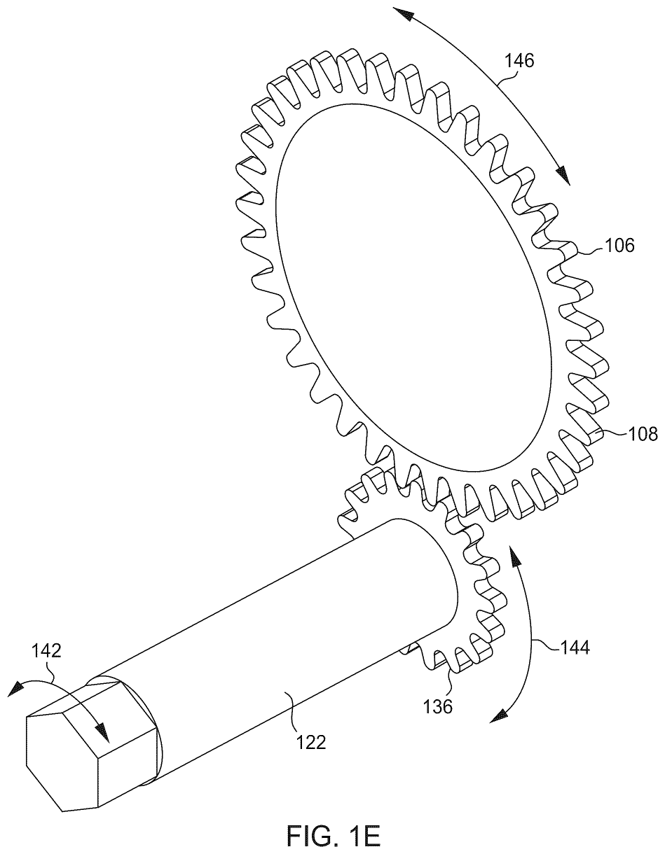

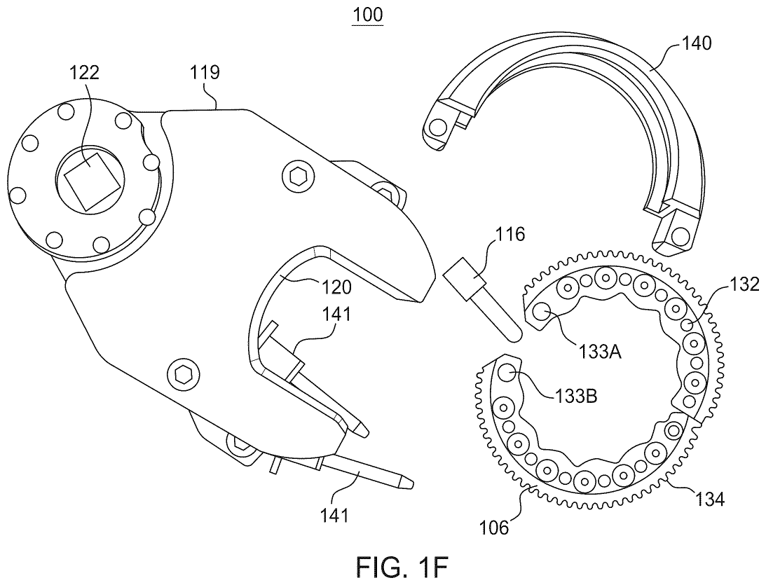

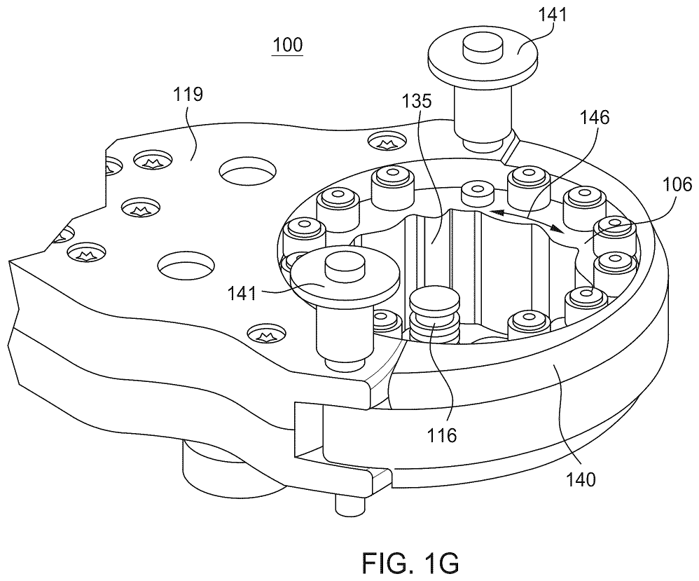

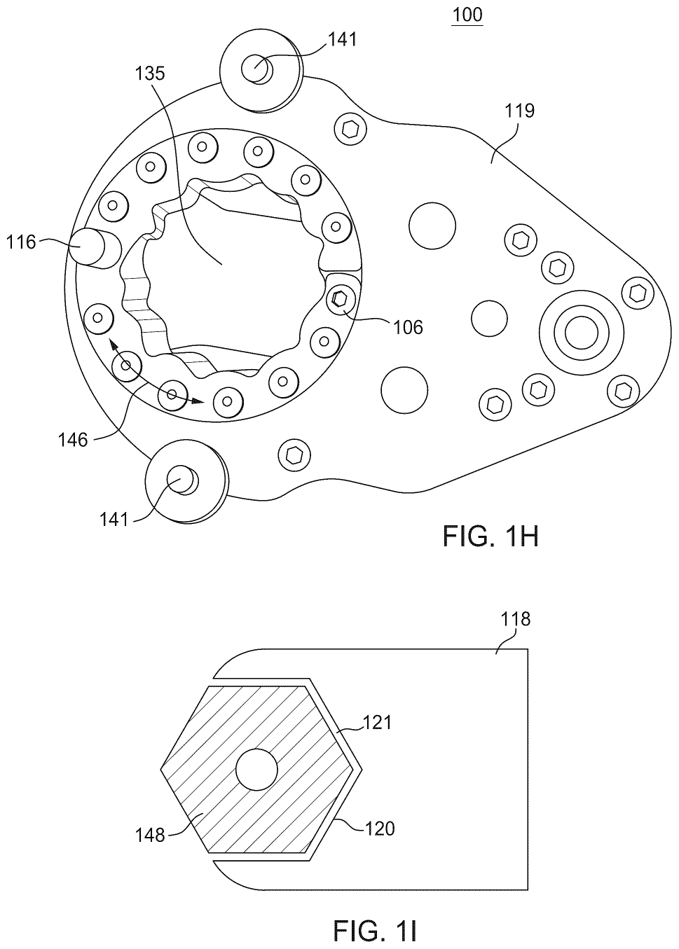

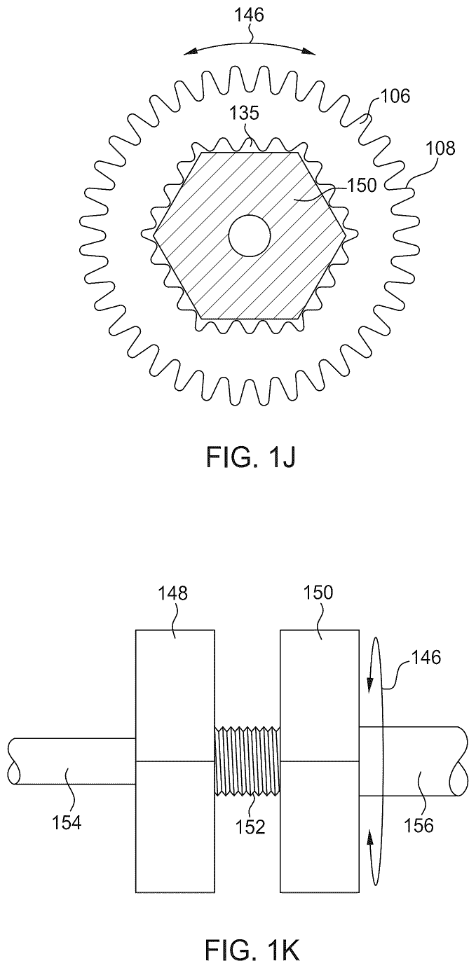

FIGS. 1A through 1C illustrate an example tool 100. FIG. 1A provides an isometric side view of the tool 100. As seen in FIG. 1A, the tool 100 resembles a flat disc. The tool 100 includes a plate 102, a plate 104, and a clasp 106. Generally, the clasp 106 is positioned and secured between the plate 102 and the plate 104. The clasp 106 may engage a first nut (e.g., a male B-nut). The clasp 106 may then be turned to rotate the nut.

The plate 102 and the plate 104 may provide mechanical or structural support for the other components of the tool 100. The plate 102 and the plate 104 may be made of any material (e.g., plastic, metal, wood, etc.). Various fasteners (e.g., screws, bolts, pins, rods, etc.) may extend into the plate 102 and/or the plate 104 to secure various components of the tool 100.

The clasp 106 is positioned between the plate 102 and the plate 104. As seen in FIG. 1A, the clasp 106 includes gear teeth 108 formed on the outer perimeter of the clasp 106. The gear teeth 108 may engage another gear that can be turned to turn the clasp 106. The tool also includes a support 110 and a support 112 that include pins 114 that extend into the plate 102. The pins 114 may also extend through the clasp 106 and into the plate 104. As a result, the supports 110 and 112 and the pins 114 secure the clasp 106 between the plates 102 and 104. The support 110 may engage a portion of the clasp 106 (e.g., an upper portion), and the support 112 may engage another portion of the clasp 106 (e.g., a lower portion). Additionally, pins 116A and 116B may be inserted through the clasp 106 to secure these portions of the clasp 106 to each other. For example, the pins 116A and 116B may couple an upper portion and a lower portion of the clasp 106 together so that these portions to do not separate from each other. When one of the pins 116A is removed, these portions of the clasp 106 may separate at one point, causing the clasp 106 to open, which allows the clasp 106 to engage the first nut. When the clasp 106 is closed around the first nut, the pin 116A may be inserted through the clasp 106 to lock the clasp 106 around the first nut. The clasp 106 may then be turned to rotate the first nut. When the clasp 106 turns, the supports 110 and 112, the pins 114, and the pins 116 may rotate with the clasp 106.

The tool 100 also includes a plate 118 coupled to the plate 104 such that the plate 104 is positioned between the plate 118 and the clasp 106. The plate 102, the plate 104, and the plate 118 form a housing 119 of the tool 100.

FIG. 1B provides an isometric side view of the tool 100. FIG. 1B shows an opposite side of the tool 100 as the side shown in FIG. 1A. As seen in FIG. 1B, the plate 118 includes or forms a crowfoot 120 that defines an opening 121 in the plate 118. Generally, the crowfoot 120 may be shaped such that the crowfoot 120 may engage a second nut (e.g., a female B-nut) when the second nut is positioned within the opening 121. The opening 121 may be sized and shaped to engage a particular sized or shaped nut (e.g., a hex nut of a certain size). The crowfoot 120 may hold the second nut such that the second nut does not rotate within the crowfoot 120. As a result, the crowfoot 120 may hold the second nut steady when the clasp 106 is turned to rotate the first nut, which may cause the first nut to engage and rotate on the second nut, tightening or loosening the coupling of the first nut with the second nut.

The tool 100 also includes a shaft 122 that extends through the plate 118 and into the tool 100. A portion of the shaft 122 extends out of the tool 100. The shaft 122 may be turned (e.g., by engaging a driver to the shaft 122) to turn the clasp 106. For example, turning the shaft 122 may turn one or more gears on the inside of the tool 100. These gears may engage the gear teeth 108 of the clasp 106. As a result, turning the shaft 122 may cause the clasp 106 to turn via the gears and the gear teeth 108. Turning the clasp 106 causes the clasp 106 to rotate the first nut on the second nut.

The tool 100 also includes additional plates and fasteners (e.g., screws, bolts, rods, etc.) that couple to the plates 102, 104, and 118 to hold together the housing 119. As seen in FIG. 1B, the tool 100 includes fasteners 123 that extend into the plate 118. The fasteners 123 may extend through the plate 118 and into the plate 104 to fasten the plate 118 to the plate 104. Additionally, the tool 100 includes the plate 124 and the fasteners 126. The fasteners 126 extend through the plate 124 and into the plates 102 and 104 to fasten the plate 124 to the plates 102 and 104. The tool 100 also includes the plate 128 and the fasteners 130 (for clarity, not all of the fasteners 130 are labeled in FIG. 1B). The fasteners 130 extend through the plate 128 and into the plates 102, 104, 118, and 124 to secure the plate 128 to the plates 102, 104, 118, and 124. In this manner, the plates 124 and 128 and the fasteners 123, 126, and 130 form and hold together the housing 119 of the tool 100.

The housing 119 houses the other components of the tool 100. FIG. 1C shows an exploded view of the tool 100. As seen in FIG. 1C, the clasp 106 is positioned between the plate 102 and the plate 104. The clasp 106 includes a first portion 132 (e.g., an upper portion) and a second portion 134 (e.g., a lower portion). The first portion 132 and the second portion 134 define apertures 133 that extend through the first portion 132 and the second portion 134. The first portion 132 defines the apertures 133A and 133C at opposite ends of the first portion 132. The second portion 134 defines the apertures 133B and 133D at opposite ends of the second portion 134. The first portion 132 and the second portion 134 may be positioned with respect to each other such that the aperture 133A aligns with the aperture 133B and such that the aperture 133C aligns with the aperture 133D. The pins 116A and 116B may then be inserted through the apertures 133A, 133B, 133C, and 133D to hold the clasp 106 in a closed state. For example, the pin 116A may be inserted through the apertures 133A and 133B, and the pin 116B may be inserted through the apertures 133C and 133D. When the clasp 106 is in the closed state, the clasp 106 defines an opening 135 (e.g., a central opening). A nut may fit within the opening 135 such that when the clasp 106 turns, the clasp 106 rotates the nut. The opening 135 may be sized or shaped to engage and hold the nut.

Removing one of the pins 116 (e.g., the pin 116A) transitions the clasp 106 to an open state. In the open state, the first portion 132 may rotate about the pin 116 remaining in the clasp 106 to swing open the clasp 106. When the clasp 106 is open, the clasp 106 may be positioned around a nut, and the clasp 106 may be closed upon the nut. After closing the clasp 106, the removed pin 116 may be inserted into the corresponding apertures 133 to lock the clasp 106 in the closed state. The clasp 106 may then be turned to rotate the nut. As seen in FIG. 1C, due to the gear teeth 108 on the outer perimeter of the clasp 106, the clasp 106 resembles a gear when the clasp 106 is in the closed state.

The tool 100 also includes a gear 136 within the housing 119. The gear 136 engages the gear teeth 108 around the outer perimeter of the clasp 106. The gear 136 is also coupled to the shaft 122. When the shaft 122 turns (e.g., using a driver attached to the shaft 122), the gear 136 also turns. If the gear 136 is engaged with the gear teeth 108 on the clasp 106, then the clasp 106 also turns when the gear 136 turns. In some aspects, the clasp 106 and the gear 136 are sized such that a certain number of turns of the shaft 122 causes one complete turn of the clasp 106 (e.g., 4.1 turns of the shaft 122 causes one turn of the clasp 106). As a result, the torque exerted by the tool 100 on a nut may be determined from the number of turns of the shaft 122.

The tool 100 may include any number of gears 136 in the housing 119. For example, the tool 100 may include multiple gears 136 that form a gear train (e.g., the multiple gears 136 engage each other sequentially). The gears 136 may be sized so that a certain number of turns of the shaft 122 causes one complete turn of the clasp 106.

FIG. 1D illustrates an example driver 138. The driver 138 engages the shaft 122 (not shown) of the tool 100. The driver 138 may then turn the shaft 122 in a controller manner. For example, the driver 138 may turn the shaft 122 in a certain direction for a selected or programmed number of turns, which results in the clasp 106 in the tool 100 turning for a certain number of turns and which results in the tool 100 exerting a certain amount of torque on a nut. By controlling the number of turns that the driver 138 turns the shaft 122 (e.g., 4.1 turns), the amount of torque exerted on the nut is controlled.

As seen in FIG. 1D, the shape of the tool 100 resembles a flat disc, which allows the tool 100 to fit in a tight space. As a result, the tool 100 may easily engage nuts (e.g., a coupling of B-nuts for an aircraft fuel line) in a confined or obstructed space. The portion of the tool 100 that includes the shaft 122 may extend out from the confined or obstructed space to provide clearance for the driver 138 to engage the shaft 122. In this manner, the tool 100 allows the nuts to be tightened even though the nuts may be difficult to reach.

FIG. 1E illustrates an example portion of the tool 100 of FIG. 1A. As seen in FIG. 1E, the gear 136 is coupled to the shaft 122. The gear 136 also engages the gear teeth 108 on the outer perimeter of the clasp 106. The shaft 122 may be turned in the directions shown by the arrows 142. The gear 136 turns with the shaft 122 in the directions shown by the arrows 144. Because the gear 136 engages the gear teeth 108, the turning of the gear 136 causes the clasp 106 to turn in the directions shown by the arrows 146.

FIGS. 1F through 1K illustrate an example tool 100. FIG. 1F shows a disassembled version of the tool 100. As seen in FIG. 1F, the tool 100 includes the housing 119 and the clasp 106. The clasp 106 includes the first portion 132 and the second portion 134. The first portion 132 defines the aperture 133A and the second portion defines the aperture 133B. The clasp 106 is shown in the open state. The pin 116 may be inserted through the apertures 133A and 133B when the apertures 133A and 133B are aligned to lock the clasp 106 in the closed state. The clasp 106 may be inserted or positioned in the housing 119 before locking the clasp 106 in the closed state. The clasp 106 may be inserted into the housing 119 such that the clasp 106 is positioned adjacent to and behind the crowfoot 120. Turning the shaft 122 then causes the clasp 106 to turn.

The tool 100 also includes a strap 140 that may be secured to the housing 119 using the pins 141 such that the strap 140 is positioned around a portion of the outer perimeter of the clasp 106 when the clasp 106 is positioned in the housing 119. In this manner, the strap 140 keeps the clasp 106 from disengaging or falling out of the housing 119. When the clasp 106 turns, the clasp 106 may turn within the housing 119 and the strap 140.

FIG. 1G shows a side view of an assembled version of the tool 100. The clasp 106 is positioned within the housing 119. Additionally, the strap 140 is engaged to the housing 119 using the pins 141. As seen in FIG. 1G, the pins 141 are inserted into the housing and through the strap 140 at opposite ends of the housing 119 and strap 140 to secure the strap 140 to the housing 119. The strap 140 is positioned around a portion of the outer perimeter of the clasp 106, which keeps the clasp 106 from disengaging or falling out of the housing 119. Additionally, the pin 116 is inserted through the clasp 106 to lock the clasp 106 in the closed state. The shaft 122 (not shown) may then be turned to turn the clasp 106. When the clasp 106 turns, the clasp 106 turns in the directions shown by the arrows 146.

FIG. 1H shows a top view of the assembled version of the tool 100. The clasp 106 is positioned within the housing. The pin 116 is inserted into the clasp 106 to lock the clasp 106 in the closed state. A nut may be positioned in the opening 135 defined by the clasp 106 so that when the clasp 106 turns (e.g., in the directions shown by the arrows 146), the nut rotates to tighten or loosen the nut. The opening 135 may be sized or shaped to engage and hold the nut.

In an example operation, the crowfoot 120 of the tool 100 engages a female B-nut (e.g., of an aircraft fuel line). The crowfoot 120 may be sized and or shaped to engage the female B-nut. The clasp 106 is in the open state in the housing 119 and positioned around a male B-nut. The clasp 106 is then closed and locked in the closed state by inserting the pin 116 such that the male B-nut is positioned in the opening 135 defined by the clasp 106 and such that the male B-nut is proximate to or engaging the female B-nut. The shaft 122 is then turned (e.g., using the driver 138) to turn the clasp 106. Turning the clasp 106 causes the male B-nut to rotate to tighten the coupling between the male B-nut and the female B-nut. The shaft 122 may be turned until the clasp 106 has turned a certain number of times to exert a certain torque on the male B-nut.

FIG. 1I shows the crowfoot 120 engaging a nut 148. The nut 148 may be a female B-nut. As seen in FIG. 1I, the crowfoot 120 engages the nut 148 such that the nut 148 is positioned with the opening 121 defined by the crowfoot 120. The opening 121 is sized or shaped to engage and hold the nut 148. The crowfoot 120 may hold and secure the nut 148.

FIG. 1J shows the clasp 106 engaging a nut 150. The nut 150 may be a male B-nut. As seen in FIG. 1J, the clasp 106 engages the nut 150 such that the nut 150 is positioned within the opening 135 defined by the clasp 106. When the clasp 106 turns in the directions shown by the arrows 146, the clasp 106 rotates the nut 150.

FIG. 1K shows a coupling between the nut 148 and the nut 150. A hose 154 may be coupled to the nut 148, and a hose 156 may be coupled to the nut 150. A threaded portion 152 may extend from the nut 150. The threaded portion 152 may engage the nut 148 to form the nut coupling. Turning the nut 150 in the directions shown by the arrows 146 may tighten or loosen the nut coupling. The nut coupling may couple the hose 154 with the hose 156 so that fluid may flow between the hoses 154 and 156. Tightening the coupling may prevent the fluid from leaking out between the nuts 148 and 150. In some aspects, the nut 148, nut 150, threaded portion 152, hose 154, and hose 156 may form a portion of a fuel line in an aircraft.

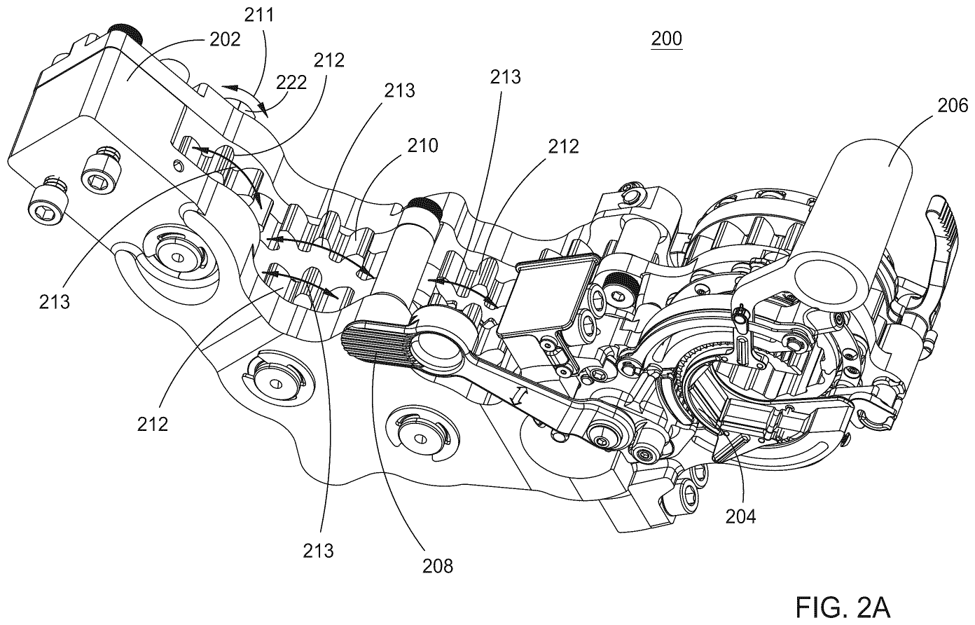

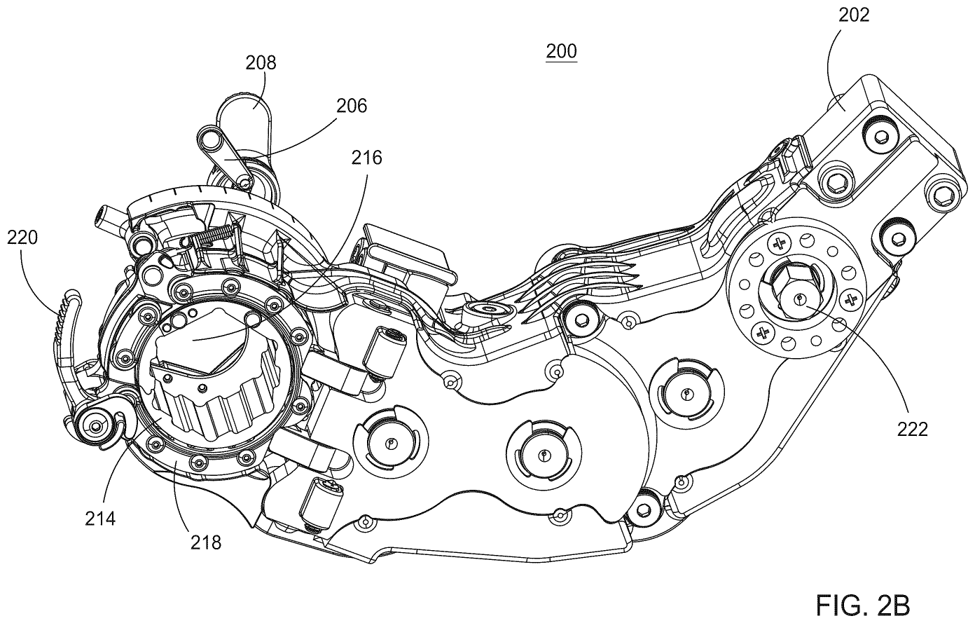

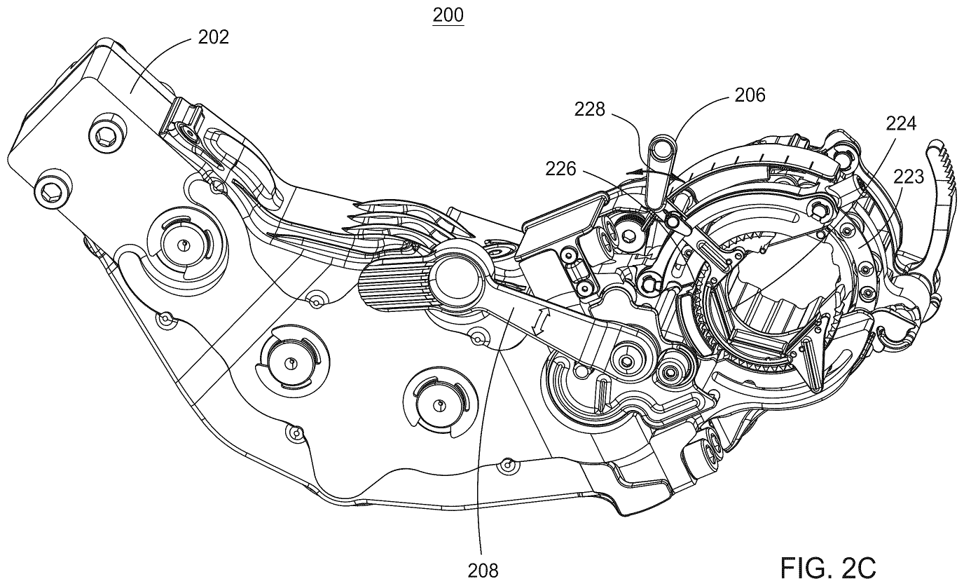

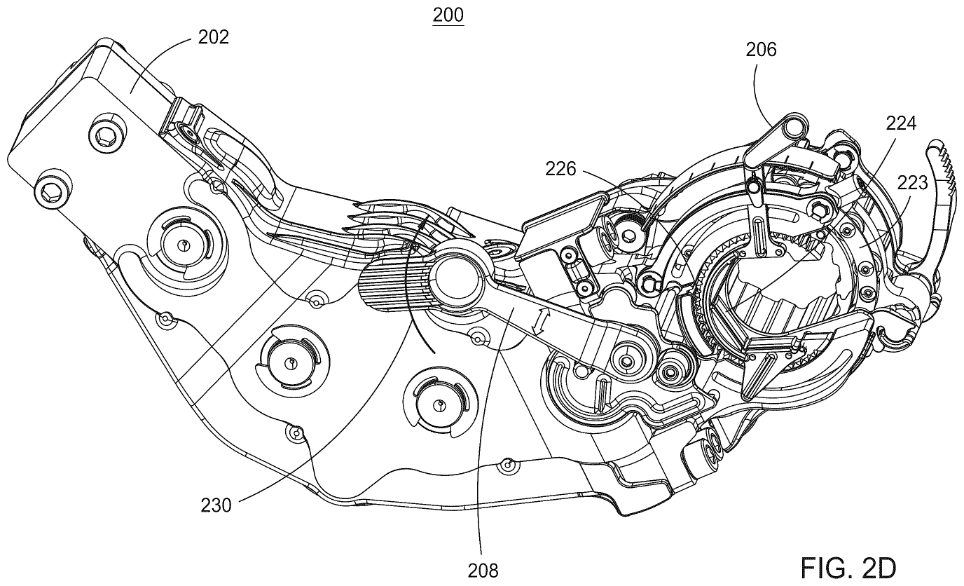

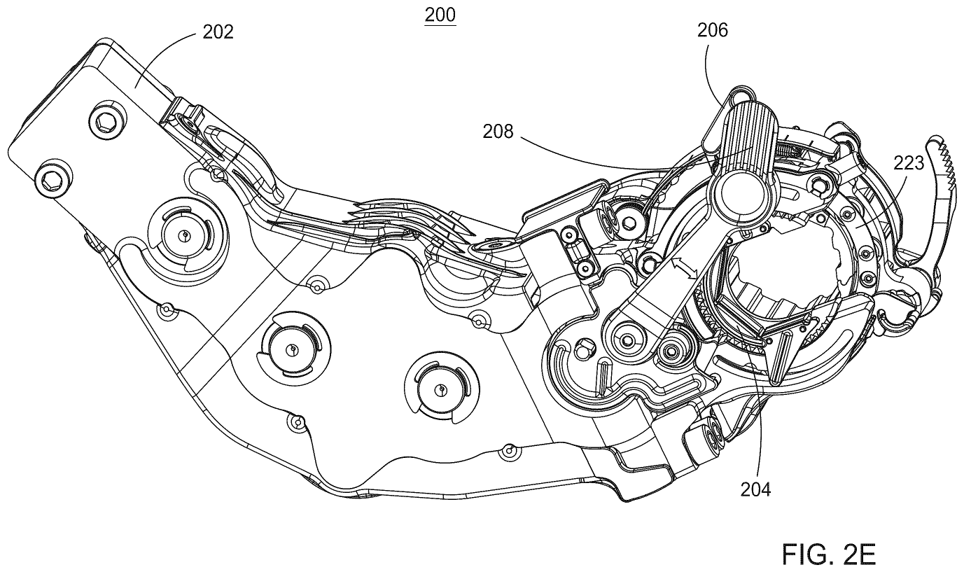

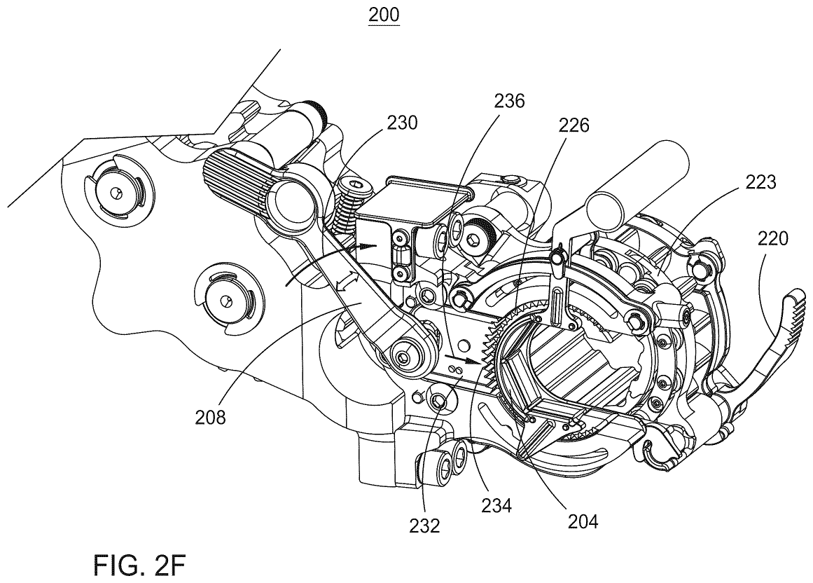

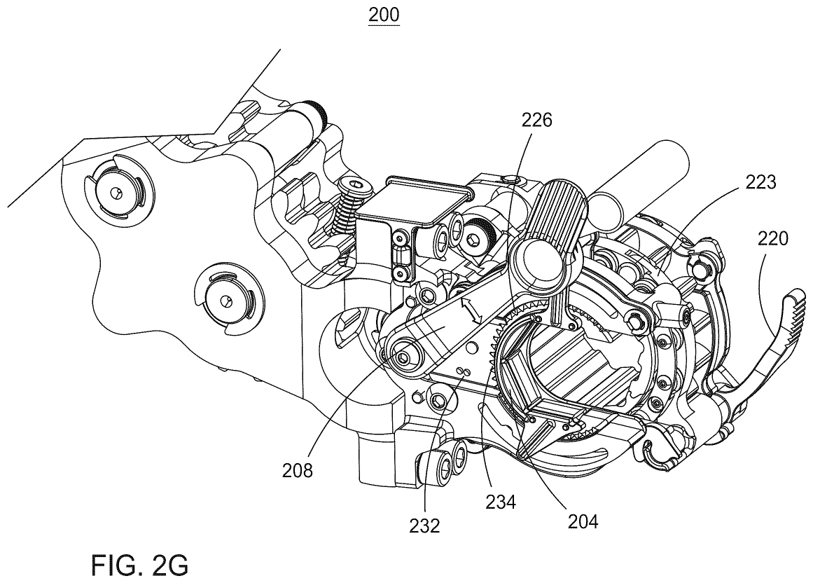

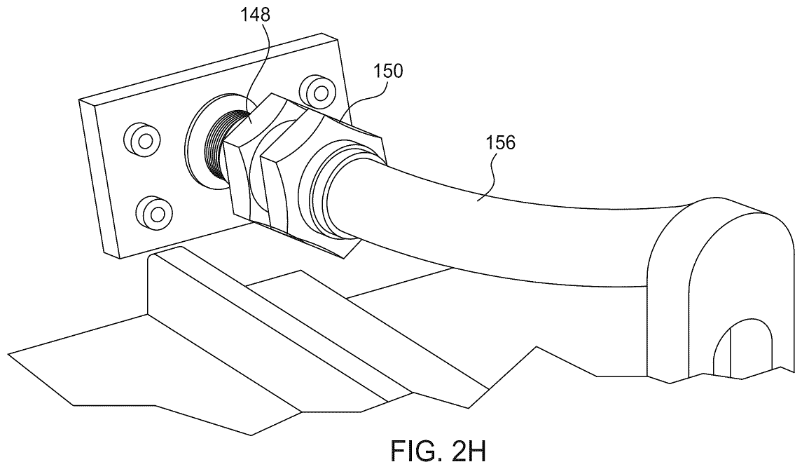

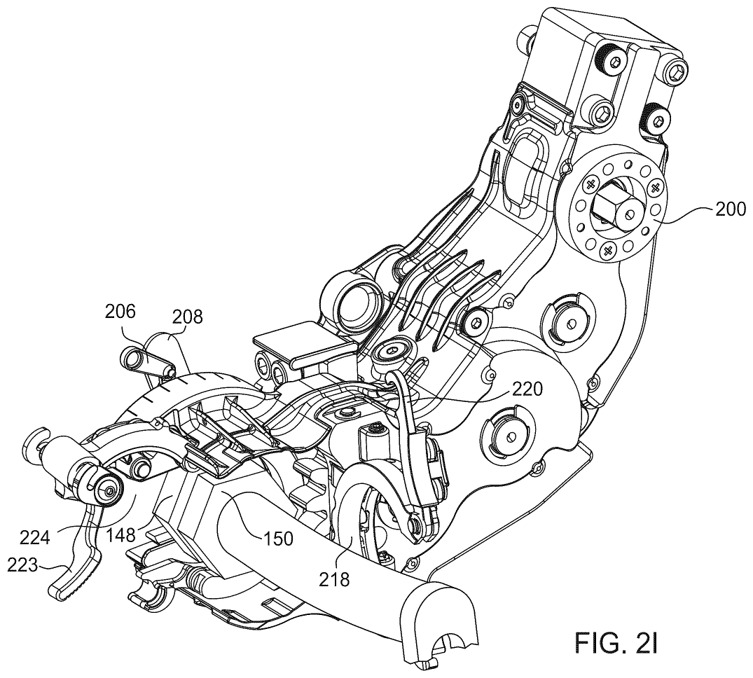

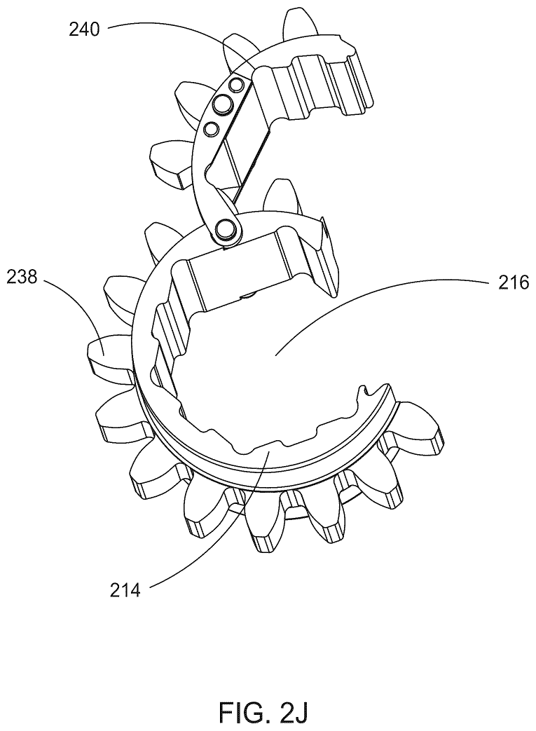

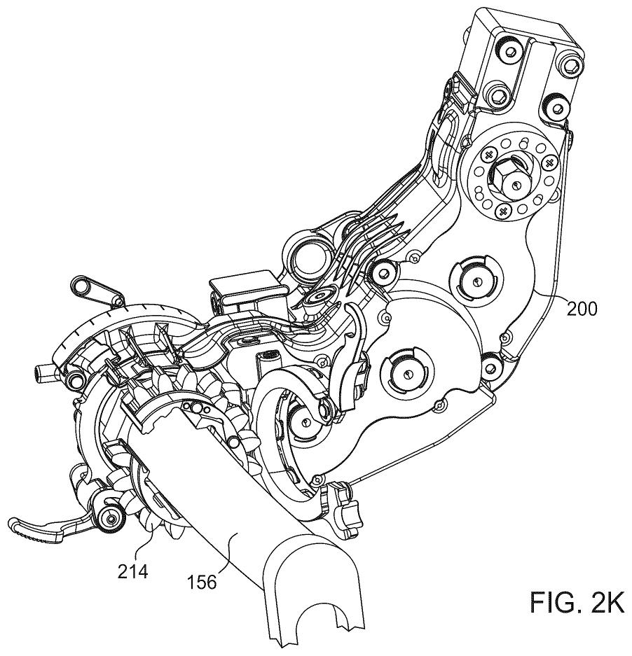

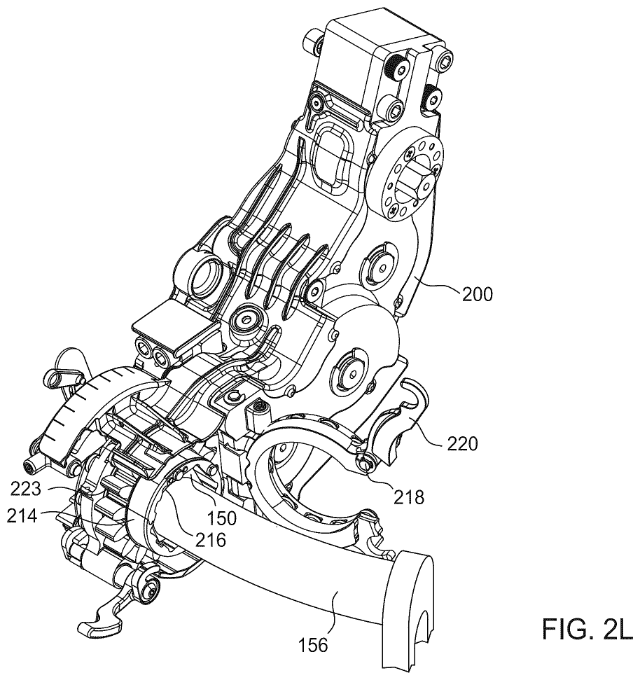

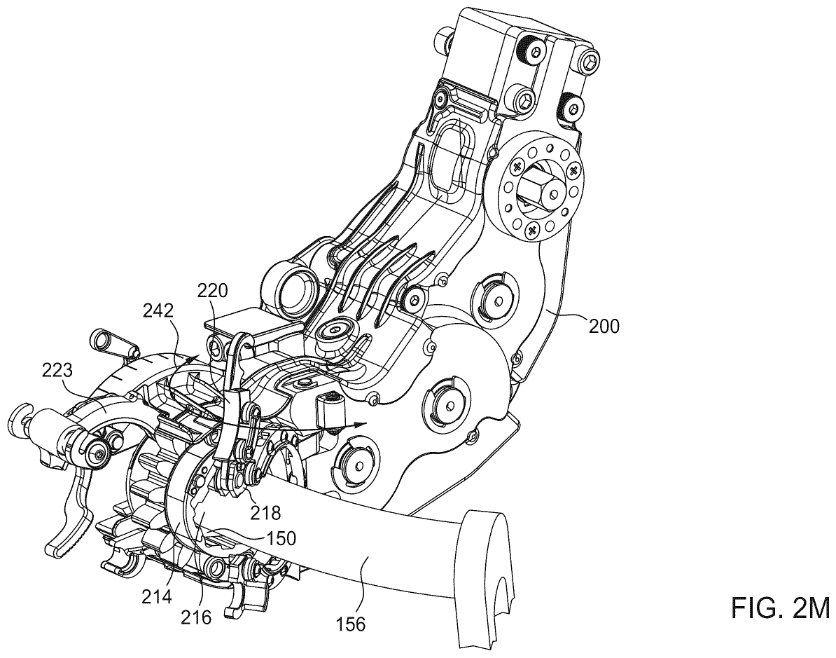

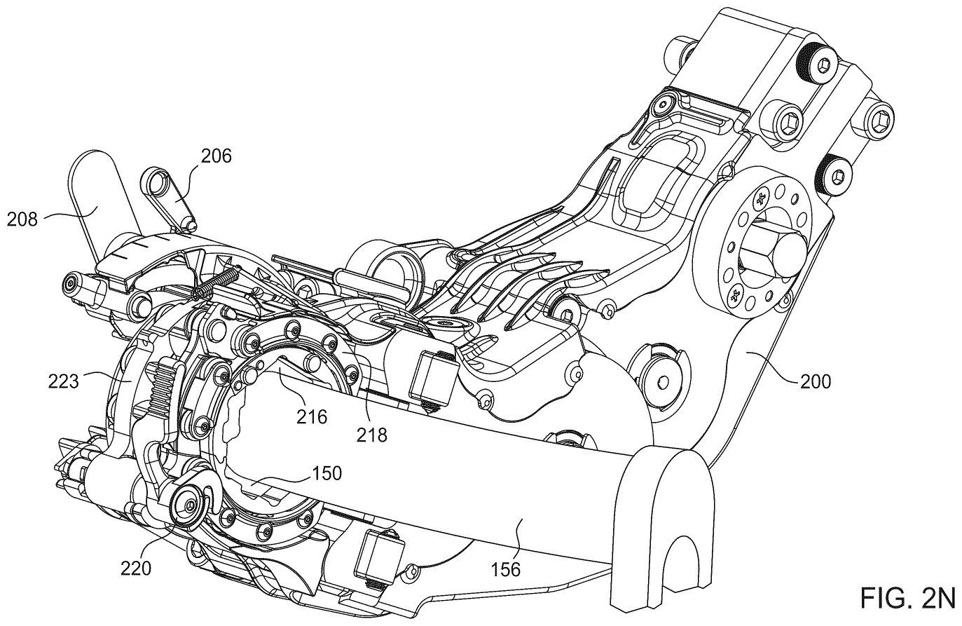

As explained previously, the tool may be made in different sizes and shapes such that the tool can access different locations and/or around different obstructions. FIGS. 2A through 2G illustrate an example tool 200. Generally, the tool 200 has a linear or arced shape (as opposed to a flat disc shape). This shape allows the tool 200 to reach around different obstructions to access a nut coupling. Additionally, the shaft of the tool 200 may extend out from the obstructions to allow easier access by a driver to turn the shaft, which tightens or loosens the nut coupling.

FIG. 2A shows a side view of the tool 200. As seen in FIG. 2A, the tool 200 includes a housing 202, which may be made of any material (e.g., metal, plastic, wood, etc.). Various components of the tool 200 are positioned within or on the housing 202. Additionally, the housing 202 forms the general shape of the tool 200. In the example of FIG. 2A, the housing 202 is arc shaped, which may allow the tool 200 to reach around different obstructions to access a nut coupling.

The tool 200 includes a crowfoot 204 at an end of the housing 202.

Generally, the crowfoot 204 may be shaped to fit around a nut (e.g., a female B-nut) and to grip or hold the nut so that the nut does not move. The tool 200 also includes a lever 206 attached to the housing 202 and the crowfoot 204. The lever 206 can be moved to rotate the crowfoot 204. Rotating the crowfoot 204 may align the shape of the crowfoot 204 with the nut so that the crowfoot 204 can engage and hold the nut. Using the lever 206 to rotate the crowfoot 204 may allow the crowfoot 204 and the tool 200 to align with a nut in any orientation without having to rotate or move the tool 200 itself, which allows the tool 200 to tighten or loosen nuts in confined spaces.

The tool 200 also includes a lever 208 attached to the housing 202. The lever 208 may be moved to lock and unlock the crowfoot 204. In some aspects, moving the lever 208 may cause a locking plate to engage or disengage the crowfoot 204. When the locking plate engages the crowfoot 204, the locking plate prevents the crowfoot 204 from rotating. When the locking plate disengages the crowfoot 204, the crowfoot 204 may be rotated (e.g., by moving the lever 206). Generally, after the crowfoot 204 engages a nut, the lever 208 may be moved to lock the crowfoot 204 and to prevent the crowfoot 204 from rotating. In this manner, the crowfoot 204 holds the nut steady.

The tool also includes a gear train 210 positioned within the housing 202. The gear train 210 includes multiple gears 212 that engage each other. For example, the gears 212 may engage each other sequentially along a length of the housing 202. Turning one gear 212 near an end of the housing 202 may cause a gear 212 near the opposite end of the housing 202 to turn. As seen in FIGS. 2A, the gears 212 may turn in the directions shown by the arrows 213. The tool 200 also includes a shaft 222 near an end of the housing 202 that is opposite the end of the housing 202 with the crowfoot 204. The shaft 222 may be turned (e.g., using a driver) in the directions shown by the arrows 211 to turn the gears 212 of the gear train 210.

FIG. 2B shows a side view of the tool 200. Generally, FIG. 2B shows a side of the tool 200 that is opposite the side shown in FIG. 2A. In the view of FIG. 2B, the housing 202 has been extended to cover the gear train 210 in the tool 200. As seen in FIG. 2B, the tool 200 includes a clasp 214. The clasp 214 may be positioned adjacent to the crowfoot 204 (e.g., in front of the crowfoot in the perspective shown in FIG. 2B). The clasp 214 defines an opening 216 that is central to the clasp 214. The clasp 214 and the opening 216 may be shaped to engage a nut (e.g., a male B-nut) such that the nut fits within the opening 216. The opening 216 may be sized or shaped to engage and hold the nut. Turning the shaft 222 and the gears 212 of the gear train 210 may cause the clasp 214 to turn. For example, the clasp 214 may engage one or more gears 212 of the gear train 210 such that when the gears 212 turn, the clasp 214 also turns. Turning the clasp 214 may cause the clasp 214 to rotate a nut in the opening 216. Rotating the nut may tighten or loosen a nut coupling using the nut and another nut held or secured by the crowfoot 204.

The tool 200 also includes a gate 218 that holds or secures the clasp 214 in the housing 202. In the example of FIG. 2B, the gate 218 is closed. The gate 218 may swing open to allow the clasp 214 to be removed from the housing 202. When the clasp 214 has been positioned in the housing 202, the gate 218 may be swung closed to secure the clasp 214 within the housing 202. As a result, the clasp 214 may not fall out of the housing 202 when the clasp 214 turns (e.g., by turning the shaft 222). Additionally, the tool 200 includes a latch 220 that may be moved to lock the gate 218 when the gate is closed. By locking the gate 218, the latch 220 prevents the gate 218 from swinging open and allowing the clasp 214 to fall out of the housing 202. To open the gate 218, the latch 220 may first be moved to unlock the gate 218. The gate 218 may then be swung open.

FIG. 2C shows a side view of the tool 200. Generally, the side of the tool 200 shown in FIG. 2C is opposite the side of the tool 200 shown in FIG. 2B. As seen in FIG. 2C, the tool 200 includes a latch 223 positioned at an end of the housing 202. Generally, the latch 223 may be opened to allow access to an opening 224 defined by the crowfoot 204. For example, when the latch 223 is opened, a nut may be positioned through the opening created by the latch 223 into the opening 224. The lever 206 may be moved to rotate the crowfoot 204 to align the opening 224 with the shape of the nut. For example, the lever 206 may be moved in the directions shown by the arrows 228 to rotate the crowfoot 204 and the opening 224. When the opening 224 is aligned with the nut, the crowfoot 204 may engage and hold the nut. The latch 223 may then be closed to retain the nut in the opening 224. The opening 224 may be sized or shaped to engage and hold the nut.

FIG. 2D shows a side view of the tool 200. As seen in FIG. 2D, the lever 206 has been moved relative to the position of the lever 206 shown in FIG. 2C. As a result, the crowfoot 204 and the opening 224 shown in FIG. 2D have rotated relative to their positions in FIG. 2C. By rotating the crowfoot 204, the opening 224 may be aligned with the shape of a nut without moving or rotating the entire tool 200.

Additionally, the tool 200 includes teeth 226 formed on an outer perimeter of the crowfoot 204. The teeth 226 may be used to lock the crowfoot 204 to prevent the crowfoot 204 from further rotating. For example, the lever 208 may be moved in the directions shown by the arrow 230 to lock the crowfoot 204. In the example of FIG. 2D, the lever 208 is in a position that causes the crowfoot 204 to be unlocked. As a result, the crowfoot 204 may rotate (e.g., by moving the lever 206). When the lever 208 is moved in the direction of the arrow 230, the lever 208 may cause a locking plate to engage the teeth 226, which locks the crowfoot 204. By locking the crowfoot 204, the crowfoot 204 is prevented from rotating.

FIG. 2E shows a side view of the tool 200. As seen in FIG. 2E, the lever 208 has been moved to lock the crowfoot 204. As a result, the crowfoot 204 does not rotate. In some aspects, the lever 206 also cannot be moved to rotate the crowfoot 204 when the crowfoot 204 is locked. The latch 223 may be closed to secure a nut within the opening 224 of the crowfoot 204. In this manner, the crowfoot 204 engages a nut and secures or holds the nut steady so that the nut does not rotate.

FIG. 2F shows a portion of the tool 200. As seen in FIG. 2F, the tool 200 includes a locking plate 232 coupled to the lever 208. The locking plate 232 includes teeth 234 on a side of the locking plate 232 near the crowfoot 204. When the lever 208 is moved in the direction shown by the arrow 230, the locking plate 232 moves in the direction shown by the arrow 236, causing the teeth 234 to engage the teeth 226 on the crowfoot 204. When the teeth 234 engage the teeth 226, the crowfoot 204 is locked and prevented from further rotating.

Additionally, as seen in FIG. 2F, the latch 223 and the latch 220 are closed, which prevents the tool 200 from disengaging a nut held by the crowfoot 204 or a nut held by the clasp 214 (not shown).

FIG. 2G shows a portion of the tool 200. AS seen in FIG. 2G, lever 208 has been moved such that the locking plate 232 moves towards the crowfoot 204. The teeth 234 are engaging the teeth 226, which prevents the crowfoot 204 from further rotating. The latches 223 and 220 are also closed. As a result, in this state, the crowfoot 204 holds or secures a nut.

FIG. 2H illustrates an example nut coupling. The nut coupling may be tightened or loosened using the tool 100 or tool 200. As seen in FIG. 2H, the nut coupling is between a nut 148 and a nut 150. In some aspects, the nut 148 is a female B-nut, and the nut 150 is a male B-nut. A hose 156 may be attached to the nut 150. As a result, the coupling of the nuts 148 and 150 may couple fluid hoses (e.g., to complete fuel lines in an aircraft). The tool 100 or the tool 200 may engage the nuts 148 and 150. The tool 100 or the tool 200 may then turn the nut 150 while holding or securing the nut 148 to tighten or loosen the coupling between the nut 148 and the nut 150.

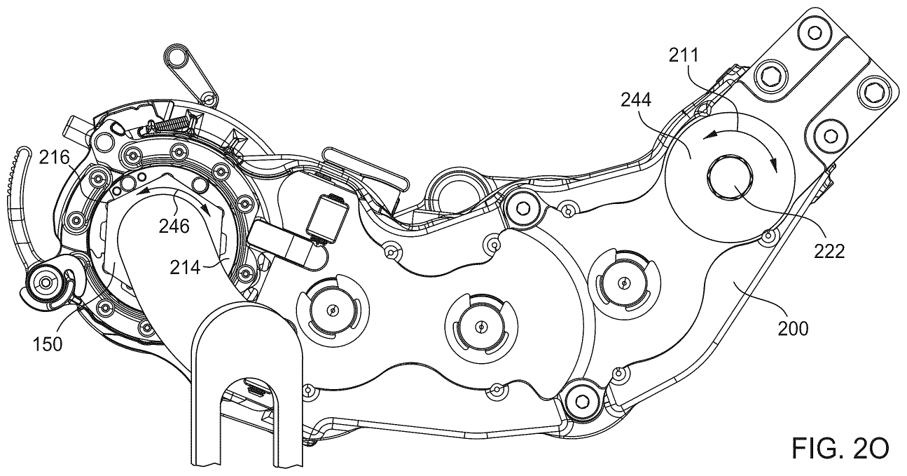

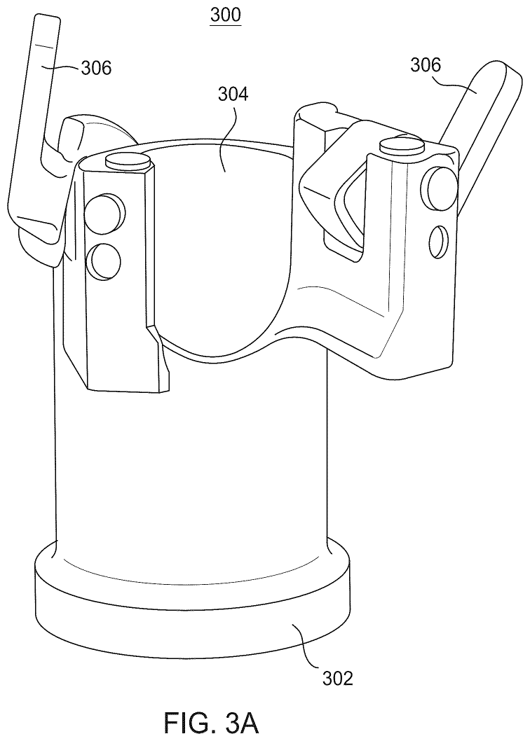

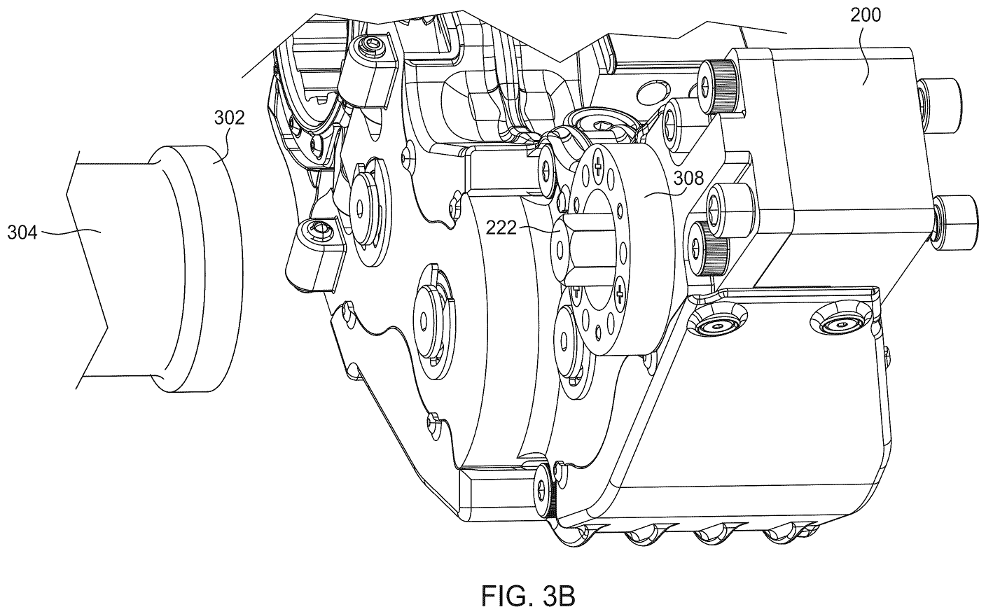

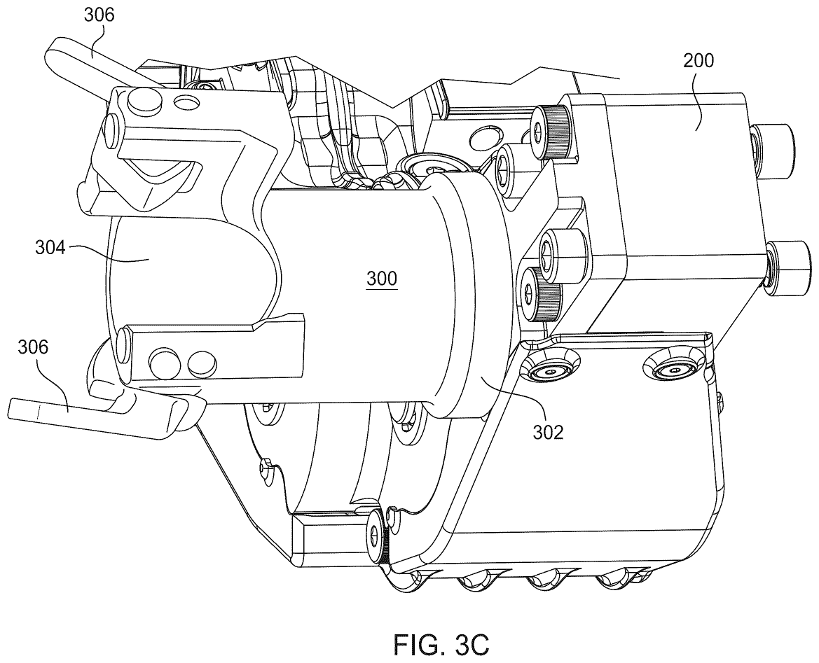

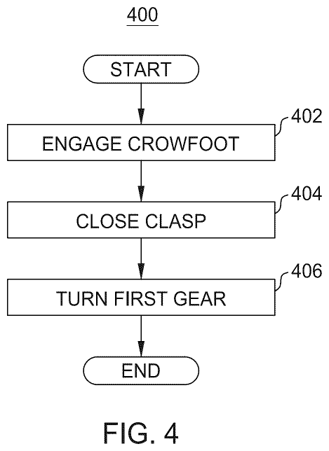

FIGS. 2I through 20 illustrate an example tool 200 engaging the nut coupling. As seen in FIG. 2I, the tool 200 may be positioned such that the nut 148 is positioned within the opening 224. The latch 223 may be opened so that the nut 148 may be positioned within the opening 224. The lever 206 may be moved to rotate the crowfoot so that the opening 224 aligns with the nut 148. When the nut 148 is aligned with the opening 224 and the opening 224 engages the nut 148, the lever 208 may be moved to lock the crowfoot to prevent further rotation of the crowfoot. As a result, the tool 200 holds and secures the nut 148.

FIG. 2J shows the clasp 214. Generally, the clasp 214 may be positioned on the nut 150 to turn the nut 150. The clasp 214 includes teeth 238 formed on an outer perimeter of the clasp 214. These teeth 238 may engage the gear train 210 so that the clasp 214 turns when the gear train 210 is turned (e.g., by turning the shaft 222). The clasp 214 also includes a portion 240 that swings open and closed with the rest of the clasp 214. By swinging the portion 240 open, the clasp 214 may be position on the hose 156 or the nut 150 such that the nut 150 is positioned within the opening 215 defined by the clasp 214. The portion 240 may then be swung closed to prevent the clasp 214 from disengaging the hose 156 or the nut 150.

FIG. 2K shows the clasp 214 positioned on the hose 156. As seen in FIG. 2K, the clasp 214 may have been opened and positioned on the hose 156. After the clasp is positioned on the hose 156, the clasp 214 is closed so that the clasp 214 does not disengage the hose 156. The clasp 214 may then be slid along the hose towards the tool 200 so that the clasp 214 engages the nut 150.

FIG. 2L shows the clasp 214 engaging the nut 150. As seen in FIG. 2L, the clasp 214 is positioned within the tool 200 and engages the nut 150 such that the nut 150 is positioned in the opening 216 defined by the clasp 214. The gate 218 may be swung open to allow the clasp 214 to slide along the hose 156 and onto the nut 150.

FIG. 2M shows the gate 218 being closed. After the clasp 214 is positioned on the nut 150, the gate 218 may be swung closed to secure the clasp 214 within the tool 200 and to prevent the clasp 214 from disengaging the nut 150. By swinging the gate 218 closed, the gate 218 is moved in the direction of the arrow 242. The latch 220 may be kept open so that the hose 156 does not prevent the gate 218 from swinging closed.

FIG. 2N shows the gate 218 closed, which prevents the clasp 214 from disengaging the nut 150. As a result, the nut 150 is secured within the opening 216. The latch 220 and the latch 223 are closed to prevent the tool 200 from disengaging the nut 148 and the nut 150. In this state, the tool 200 has engaged the nut 148 and the nut 150.

FIG. 2O shows the shaft 222 being turned. For example, a knob 244 may be attached to the shaft 222. Turning the knob 244 may cause the shaft 222 to turn. In the example of FIG. 2O, the knob 244 and the shaft 222 may turn in the directions shown by the arrows 211. Turning the knob 244 and the shaft 222 may turn the gear train 210 in the tool 200. The teeth 238 on the clasp 214 may engage the gears 212 in the gear train 210. When the gears 212 in the gear train 210 turn, the clasp 214 may also turn, which rotates the nut 150 to tighten or loosen the coupling with the nut 148. The clasp 214 may turn in the directions shown by the arrows 246. When the clasp 214 turns and rotates the nut 150, the crowfoot 204 may hold the nut 148 steady, which allows the nut 150 to turn against the nut 148.

In some aspects, the gears 212 in the gear train 210 are sized so that a certain number of turns of the shaft 222 causes one complete turn of the clasp 214 and the nut 150. As a result, the amount of torque exerted by the tool 200 onto the nut 150 may be determined from the number of turns of the shaft 222.

FIGS. 3A through 3C illustrate an example coupler 300. Generally, the coupler 300 may be attached to the shaft 122 or the shaft 222. A driver may then be attached to the coupler 300. The driver may turn the coupler 300 to turn the shaft 122 or the shaft 222, which turns the clasp 106 or the clasp 214.

FIG. 3A shows the coupler 300. As seen in FIG. 3A, the coupler 300 includes an end 302 and an end 304 opposite the end 302. The end 302 may be shaped to engage the shaft 122 or the shaft 222. The end 304 may be shaped to engage a driver. The coupler 300 also includes latches 306 positioned by the end 304. When the driver is engaging the coupler 300 at the end 304, the latches 306 may be moved to secure or lock the driver to the coupler 300.

FIG. 3B shows the coupler 300 and the tool 200. As seen in FIG. 3B, the tool 200 includes a ring 308 positioned around the shaft 222. The end 302 of the coupler 300 may engage the ring 308. As a result, the shaft 222 may be positioned within the coupler 300. Turning the shaft 222 and/or the ring 308 may turn the gears and clasp of the tool 200.

FIG. 3C shows the coupler 300 engaged with the tool 200. As seen in FIG. 3C, the coupler 300 engages the tool 200 at the end 302. The end 304 may then be positioned to engage a driver. When the driver is engaged with the coupler 300 at the end 304, the latches 306 may be moved to lock or secure the driver to the coupler 300. The driver may then be activated to turn the coupler 300, which turns the shaft 222.

FIG. 4 is a flowchart of an example method 400 for tightening or loosening a nut 150. In particular aspects, the tool 100 or the tool 200 perform the method 400. By performing the method 400, the tool 100 or the tool 200 tighten or loosen a nut coupling between the nut 148 and the nut 150.

In block 402, the crowfoot 120 of the tool 100 or the crowfoot 204 of the tool 200 engages the nut 148. By engaging the nut 148, the nut 148 is positioned within the opening 121 defined by the crowfoot 120 or the opening 224 defined by the crowfoot 204. Additionally, the crowfoot 120 or the crowfoot 204 may hold or secure the nut 148 so that the nut 148 does not rotate.

In block 404, the clasp 106 or the clasp 214 is closed around the nut 150. By closing the clasp 106 or the clasp 214 around the nut 150, the nut 150 is positioned within the opening 135 defined by the clasp 106 or the opening 216 defined by the clasp 214.

In block 406, a gear 136 of the tool 100 or a gear 212 of the tool 200 is turned. The gear 136 or the gear 212 may engage teeth 108 or teeth 238 around the outer perimeter of the clasp 106 or the clasp 214. As a result, when the gear 136 or the gear 212 turns, the clasp 106 or the clasp 214 also turns. The gear 136 or the gear 212 may be turned by turning the shaft 122 or the shaft 222. Turning the clasp 106 or the clasp 214 causes the nut 150 to rotate. Because the nut 148 is held steady by the crowfoot 120 or the crowfoot 204, the nut 150 rotates against the nut 148, which tightens or loosens the nut coupling between the nut 148 and the nut 150.

In some aspects, the gear 136 or the gear 212 is sized so that a certain number of turns of the shaft 122 or the shaft 222 causes the clasp 106 or the clasp 214 to make one complete turn. In this manner, the number of turns of the clasp 106 or the clasp 214 may be determined from the number of turns of the shaft 122 or the shaft 222. As a result, the amount of torque exerted by the clasp 106 or the clasp 214 on the nut 150 may be determined from the number of turns of the shaft 122 or the shaft 222.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

While the foregoing is directed to aspects of the present disclosure, other and further aspects of the disclosure may be devised without departing from the basic scope thereof, and the scope thereof is determined by the claims that follow.

What is claimed is:

1. An apparatus comprising:
a crowfoot defining a first opening sized to engage a first nut;
a clasp arranged to close such that the clasp defines a second opening sized to engage a second nut, wherein the clasp comprises gear teeth positioned along a portion of an outer perimeter of the clasp; and
a first gear arranged to engage the gear teeth such that turning the first gear causes the clasp to turn to rotate the second nut such that the second nut engages the first nut when the crowfoot is engaged with the first nut and when the clasp is engaged with the second nut.

2. The apparatus of claim 1, further comprising a pin, wherein the clasp defines a first aperture and a second aperture, wherein the first aperture aligns with the second aperture when the clasp is closed, and wherein the pin is arranged to extend through the first aperture and the second aperture to lock the clasp.

3. The apparatus of claim 1, further comprising:
a housing, wherein the first gear and the crowfoot are positioned within the housing; and
a strap arranged to couple to the housing and to secure the clasp to the housing.

4. The apparatus of claim 1, further comprising a shaft coupled to the first gear, wherein turning the shaft causes the first gear to turn.

5. The apparatus of claim 1, further comprising a second gear arranged to engage the first gear such that turning the second gear causes the first gear to turn.

6. The apparatus of claim 1, further comprising:
a gate arranged to close to secure the clasp between the crowfoot and the gate; and
a latch arranged to lock the gate.

7. The apparatus of claim 1, further comprising a lever arranged to rotate the crowfoot to align the first opening with the first nut.

8. The apparatus of claim 1, further comprising a lever arranged to engage a locking plate to the crowfoot to secure the crowfoot.

9. A method comprising:
engaging a crowfoot with a first nut such that the first nut is positioned within a first opening defined by the crowfoot;
closing a clasp around a second nut such that the second nut is positioned within a second opening defined by the clasp, wherein the clasp comprises gear teeth positioned along a portion of an outer perimeter of the clasp, and wherein the first opening is aligned with the second opening; and
turning a first gear engaged with the gear teeth such that the clasp turns to rotate the second nut such that the second nut engages the first nut.

10. The method of claim 9, further comprising, when the clasp is closed around the second nut, inserting a pin into a first aperture and a second aperture defined by the clasp to lock the clasp.

11. The method of claim 9, further comprising coupling a strap to a housing to secure the clasp to the housing, wherein the first gear and the crowfoot are positioned within the housing.

12. The method of claim 9, further comprising turning a shaft coupled to the first gear, wherein turning the shaft causes the first gear to turn.

13. The method of claim 9, further comprising turning a second gear engaged with the first gear, wherein turning the second gear causes the first gear to turn.

14. The method of claim 9, further comprising:
closing a gate to secure the clasp between the crowfoot and the gate; and
moving a latch to lock the gate.

15. The method of claim 9, further comprising moving a lever to rotate the crowfoot to align the first opening with the first nut.

16. The method of claim 9, further comprising moving a lever to engage a locking plate to the crowfoot to secure the crowfoot.

17. An apparatus comprising:
a crowfoot defining a first opening sized to engage a female B-nut;
a clasp arranged to close such that the clasp defines a second opening sized to engage a male B-nut, wherein the clasp comprises gear teeth positioned along a portion of an outer perimeter of the clasp; and
a gear train comprising a first gear and a second gear, wherein the first gear engages the gear teeth, wherein turning the second gear causes the first gear to turn, and wherein turning the first gear causes the clasp to rotate the male B-nut such that the male B-nut engages the female B-nut when the crowfoot is engaged with the female B-nut and when the clasp is engaged with the male B-nut.

18. The apparatus of claim 17, further comprising:
a gate arranged to close to secure the clasp between the crowfoot and the gate; and
a latch arranged to lock the gate.

19. The apparatus of claim 17, further comprising a lever arranged to rotate the crowfoot to align the first opening with the female B-nut.

20. The apparatus of claim 17, further comprising a lever arranged to engage a locking plate to the crowfoot to secure the crowfoot.
